(19) United States
(12) Patent Application Publication
(10) Pub. No.: US 2026/0289290 A1
(43) Pub. Date: Sep. 24, 2026

(54) ARTIFICIAL NEURAL NETWORK LAYER COMPRISING AN ARRAY OF PHOTOTRANSISTORS AND ARTIFICIAL NEURAL NETWORK

(71) Applicant: ams International AG, Jona (CH)

(72) Inventor: Francesco Paolo D’Aleo, Samstagem (CH)

(21) Appl. No.: 18/996,099

(22) PCT Filed: Aug. 31, 2023
(86) PCT No.: PCT/EP2023/073939

§ 371 Date: Jan. 17, 2025

(30) Foreign Application Priority Data
Sep. 2, 2022 (DE) 10 2022 122 288.8

(51) Int. Cl. G06N 3/067

(52) U.S. Cl. CPC G06N 3/067

(57) ABSTRACT

In an embodiment an artificial neural network layer includes an array of phototransistors, wherein each of the phototransistors is configured to absorb electromagnetic radiation via a light-receiving surface of the phototransistor and to emit electromagnetic radiation via a light-emitting surface, wherein an intensity of the emitted electromagnetic radiation depends on an intensity of the absorbed electromagnetic radiation, wherein the intensity of the emitted electromagnetic radiation further depends on a voltage applied to at least one terminal of the phototransistor, and wherein the array of phototransistors is arranged in a plane parallel to the light-receiving surface.

### CROSS-REFERENCE TO RELATED APPLICATIONS

This patent application is a national phase filing under section 371 of PCT/EP2023/073939, filed Aug. 31, 2023, which claims the priority of German patent application no. 102022122288.8, filed Sep. 2, 2022, each of which is incorporated herein by reference in its entirety.

### TECHNICAL FIELD

Embodiments of the present disclosure generally relate to the field of artificial neural networks.

### BACKGROUND

Machine learning systems are typically based on artificial neural networks (ANNs). Optical neural networks, which are based on emission and absorption of electromagnetic radiation, are very fast. Attempts are being made to improve such neural networks.

### SUMMARY

Embodiments provide an improved artificial neural network layer, an improved artificial neural network and an improved electronic device.

For example, an artificial neural network layer comprises an array of phototransistors. Each of the phototransistors is configured to absorb electromagnetic radiation via a light-receiving surface of the phototransistor and to emit electromagnetic radiation via a light-emitting surface. An intensity of the emitted electromagnetic radiation depends on the intensity of the absorbed electromagnetic radiation. The intensity of the emitted electromagnetic radiation further depends on a voltage applied to at least one terminal of the phototransistor. The array of phototransistors is arranged in a plane parallel to the light-receiving surface.

For example, each of the phototransistors may be implemented as a bipolar junction transistor comprising a collector region adjacent to the light-receiving surface, an emitter region adjacent to the light-emitting surface, and a base region between the collector region and the emitter region. Each phototransistor is configured and biased in use so that the collector and base regions of the transistor operate as a photodiode and the base and emitter regions operate as a light-emitting diode.

The artificial network layer may further comprise a bias circuit for applying a voltage to at least one terminal of each of the phototransistors. According to further embodiments, the artificial neural network layer may further comprise a bias circuit for applying a voltage to at least one terminal of a corresponding one of the phototransistors.

The artificial neural network layer may further comprise a memory for storing voltage values applied to the at least one terminal.

According to embodiments, an artificial neural network comprises at least two artificial neural network layers as described above.

The artificial neural network may further comprise a training processor for training the neural network.

Moreover, the artificial neural network may further comprise a processor for performing image recognition. According to embodiments, the training processor and the processor for performing image recognition may be separate processors. For example, the training processor may be an external device. According to further examples, the training processors and the processor for performing image recognition may be one single processor.

The artificial neural network may further comprise a modulator or a diffuser between two neighbouring artificial neural network layers.

The artificial neural network may further comprise a mask between two neighbouring artificial neural network layers. The mask may be selected from an amplitude mask and a phase mask.

According to further embodiments, the artificial neural network may further comprise a reservoir between two neighbouring artificial neural network layers.

An electronic device comprises the artificial neural network layer or the artificial neural network as explained above. The electronic device may be selected from a gesture recognition unit, a pattern recognition unit, an image sensor and a display comprising an image sensor.

### BRIEF DESCRIPTION OF THE DRAWINGS

The accompanying drawings are included to provide a further understanding of embodiments of the invention and are incorporated in and constitute a part of this specification. The drawings illustrate the embodiments of the present invention and together with the description serve to explain the principles. Other embodiments of the invention and many of the intended advantages will be readily appreciated, as they become better understood by reference to the following detailed description. The elements of the drawings are not necessarily to scale relative to each other. Like reference numbers designate corresponding similar parts.

FIG. 1A schematically illustrates an artificial neural network layer according to embodiments;

FIG. 1B schematically illustrates a neural network according to embodiments;

FIG. 2A shows an equivalent circuit diagram of a phototransistor that may form a component of an artificial neural networks layer according to embodiments;

FIG. 2B shows a schematic representation of a phototransistor that may form a component of an artificial neural networks layer according to embodiments;

FIG. 2C illustrates a schematic cross-sectional view of a phototransistor that may form a component of an artificial neural networks layer according to further embodiments;

FIG. 2D illustrates a schematic cross-sectional view of a phototransistor that may form a component of an artificial neural networks layer according to further embodiments;

FIG. 3A schematically illustrates elements of a neural network according to embodiments;

FIG. 3B schematically illustrates components of an artificial neural network according to further embodiments;

FIG. 3C schematically illustrates components of a neural network according to further embodiments;

FIG. 3D schematically illustrates components of an artificial neural network according to further embodiments.

FIG. 3E illustrates an example of an optical grating being a component of the arrangement of FIG. 3D;

FIG. 4A schematically illustrates elements of an image sensor according to embodiments;

FIG. 4B illustrates an example of extracting specific features;

FIG. 5 schematically illustrates components of an electronic device according to embodiments;

FIG. 6A schematically illustrates elements of a gesture recognition unit;

FIG. 6B illustrates examples of gestures and corresponding signals detected by an image sensor; and

FIG. 7 shows an electronic device according to embodiments.

### DETAILED DESCRIPTION OF ILLUSTRATIVE EMBODIMENTS

In the following detailed description reference is made to the accompanying drawings, which form a part hereof and in which are illustrated by way of illustration specific embodiments in which the invention may be practiced. In this regard, directional terminology such as “top”, “bottom”, “front”, “back”, “over”, “on”, “above”, “leading”, “trailing” etc. is used with reference to the orientation of the Figures being described. Since components of embodiments of the invention can be positioned in a number of different orientations, the directional terminology is used for purposes of illustration and is in no way limiting. It is to be understood that other embodiments may be utilized and structural or logical changes may be made without departing from the scope defined by the claims.

The description of the embodiments is not limiting. In particular, elements of the embodiments described hereinafter may be combined with elements of different embodiments.

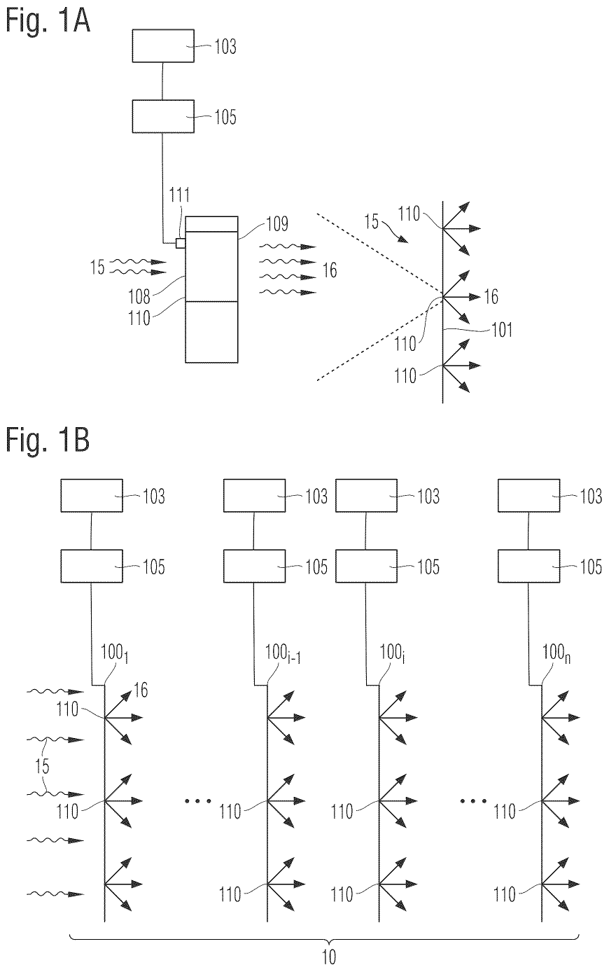

FIG. 1A illustrates an artificial neural network layer 100 according to embodiments.

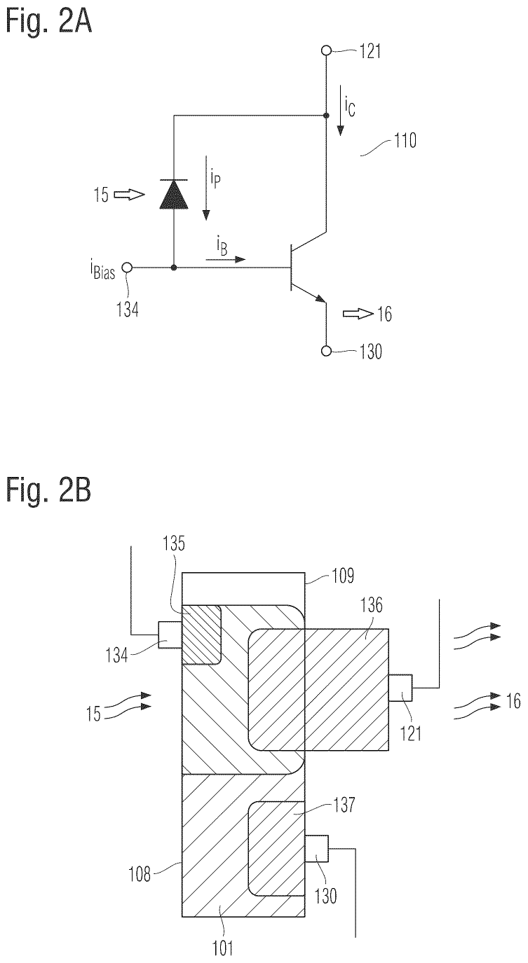

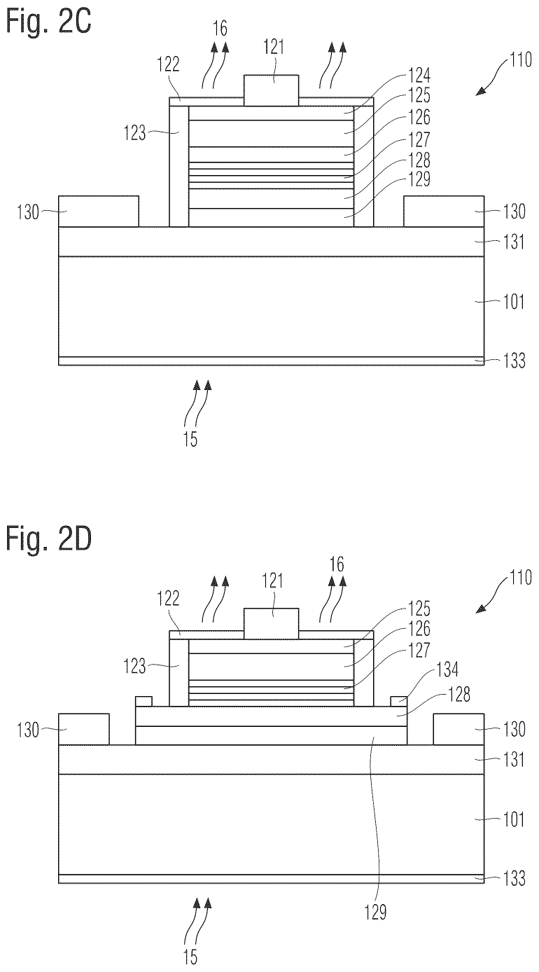

The right-hand portion of FIG. 1A illustrates the artificial neural network layer 100, and the left-hand portion of FIG. 1A shows an enlarged phototransistor 110. Specific examples of the phototransistor 110 will be discussed with reference to FIGS. 2A to 2D.

As will be explained in the following, the artificial neural network layer 100 comprises an array of phototransistors 110. Each of the phototransistors 110 is configured to absorb electromagnetic radiation 15 via a light receiving surface 108 of the phototransistor 110 and to emit electromagnetic radiation 16 via a light emitting surface 109. An intensity of the emitted electromagnetic radiation depends on the intensity of the absorbed electromagnetic radiation 15. The emitted electromagnetic radiation 16 further depends on a voltage which is applied to at least one terminal 111 of the phototransistor 110. The array of phototransistors 110 are arranged in a plane parallel to the light receiving surface 108.

As is further illustrated in the left-hand portion of FIG. 1A, a bias circuit 105 is electrically connected to the terminal 111 to apply a suitable bias voltage to the phototransistor 110. As will be explained later, weights which are applied to the artificial neural network layer may be implemented by bias voltage values that are applied to one or more terminals 111 of the respective phototransistors 110. For example, bias voltages may be stored in a memory 103 for each of the artificial neural network layers 100.

The phototransistors 110 may be arranged on a suitable substrate 101. For example, the substrate 101 may be a semiconductor substrate. The phototransistors 110 may be integrally formed in the semiconductor substrate 101. The received electromagnetic radiation and the emitted electromagnetic radiation are supposed to be quasi-Lambertian. As a consequence, as will be illustrated with reference to FIG. 1B, electromagnetic radiation emitted from a single spot is “seen” from all the input detectors or phototransistors 110 of the subsequent layer. At each phototransistor 110, the sum of all the spots or phototransistors 110 of a preceding layer arrives. As a consequence, the intensity of the emitted electromagnetic radiation 16 is decreed from the bias voltage, weights and the emitted intensity of all phototransistors 110 of the previous layer.

FIG. 1B shows an example of an artificial neural network 100. The artificial neural network 10 comprises a plurality of artificial neural network layers 100₁, 100ᵢ, . . . 100ₙ, which have been explained with reference to FIG. 1A. Each of the artificial neural network layers 100₁, 100ᵢ, . . . 100ₙ comprises the elements that have been discussed with reference to FIG. 1A. A bias circuit 105 may be provided for each of the artificial neural network layers 100ᵢ or for the entire artificial neural network. Likewise, a memory 103 for storing bias voltages may be provided for each of the artificial neural network layers 100; or may be provided for the entire artificial neural network 10. As is further illustrated in FIG. 1B, each phototransistor 100 receives the electromagnetic radiation 16 that has been emitted by each of the phototransistors 110 of the previous layer. The intensity of the electromagnetic radiation 16 which is emitted by a phototransistor 110 depends on the intensity of the absorbed electromagnetic radiation and a bias voltage that is applied to a terminal 111 of the phototransistor 110.

As a consequence, the connections between the single layers 100ᵢ₋₁, 100ᵢ, 100ᵢ₊₁ are accomplished by means of photons that are emitted by the phototransistors 110. Further, the weights of transmission from a previous layer 100ᵢ₋₁ to the subsequent layer 100ᵢ₊₁ may be set by appropriately setting weights in the form of bias voltages in layer 100ᵢ. As a consequence, the neural network 10 illustrated in FIG. 1B has a higher flexibility than a diffractive neural network.

In particular, training of the artificial neural network 10 may be accomplished by appropriately setting the weights in the form of the bias voltages that are applied to the single transistors 110. As has been described, the phototransistors are active and may be individually switched. Each of the phototransistors may amplify the incoming electromagnetic radiation. As a consequence, they are more sensitive to small incoming signals and provide higher outputs. In particular, the outputs may be amplified in dependence from a voltage applied to the terminal 111.

FIG. 2A shows an equivalent circuit diagram of a phototransistor 110 that may form a component of the artificial neural network layer 100. As is illustrated, the base of the transistor is connected so that the total current at the base corresponds to the sum of the bias current i_{bias} and photo current iₚ which is generated by incident electromagnetic radiation 15 in a pn junction.

The total current at the base of the transistor corresponds to the sum of the bias and the generated photocurrent:

$${i}_{B} = {i}_{P} + {i}_{Bias} \qquad ( 1 )$$

The photo-current may be:

$${i}_{P} = {α I}_{IN} \qquad ( 2 )$$

α expresses the input quantum efficiency.

The collector current may be determined as:

$${i}_{C} = {h}_{fe} \cdot {i}_{B} \qquad ( 3 )$$

The current gain may be adjusted because is a function of the base current drive, collector current, bias voltage, collector-emitter voltage and temperature.

$${h}_{fe} = ( , {V}_{Bias} , {V}_{CE} , T ) \qquad ( 4 )$$

Therefore, the emitted intensity of a general ith layer at the jth element may be written as:

$${I}_{OUTij} = β {i}_{Cij} = [ {h}_{Feij} ( {i}_{Pij} + {i}_{Bij} ) ] = β [ {h}_{FEij} ( {α I}_{INij} + {i}_{Bij} ) ] = {h}_{FEij} {αβ I}_{INi} + {h}_{FEij} β {i}_{Bi} \qquad ( 5 )$$

In which β is the output quantum efficiency, the weights are wᵢⱼ=h_{FEi}αβ and the biases h_{F},

the input intensity is:

$${I}_{{IN}_{i}} = {\sum }_{j = 1}^{N} {I}_{{OUT}_{i - 1 , j}}$$

Accordingly, the intensity of the emitted light 16 depends on the received electromagnetic radiation I_{IN} and further the current i_{Bias} caused by the bias voltage and the collector emitter voltage V_{CE}.

FIG. 2B shows a schematic view of a phototransistor 110 that may be formed in the substrate 101. The substrate 101 may be a semiconductor substrate. The substrate 101 may, e.g. doped with the first conductivity type, e.g. n type. A semiconductor region of the second conductivity type is arranged at the light receiving surface 108 of the substrate 101. The semiconductor region of the second conductivity type may implement a base region 135 of the bipolar phototransistor. Further, the base contact 134 is arranged at the light receiving surface 108 of the semiconductor substrate in contact with the base region 135. An emitter region 136 of the first conductivity type is arranged at the light emitting surface 109 of the semiconductor substrate. The emitter contact 121 is arranged in electrical contact with the emitter region 136. Further, the collector contact 130 may be formed adjacent to the light emitting surface 109 of the substrate 132. Accordingly, a bipolar npn phototransistor is implemented. According to further embodiments, the phototransistor may as well be implemented as a pnp transistor.

FIG. 2C shows a schematic cross-sectional view of the phototransistor 110 that may be a component of the artificial neural network. In particular, the transistor 110 implements a n-p-n transistor structure or a p-n-p transistor structure. The phototransistor 110 comprises a substrate 101. For example, the substrate 101 may be a semiconductor substrate.

Examples of semiconductor materials that may be generally used in the context of the present disclosure comprise nitride-compound semiconductors such as GaN, InGaN, AlN, AlGaN, AlGaInN, phosphide-compound semiconductors such as GaAsP, AlGaInP, GaP, AlGaP, as well as further semiconductor materials including AlGaAs, SiC, ZnSe, GaAs, ZnO, Ga₂O₃, diamond, hexagonal BN und combinations of these materials.

According to further implementations, the substrate 132 may comprise sapphire. For example, the phototransistor 110 may comprise a first semiconductor layer 125, a second semiconductor layer 128, 129 and a third semiconductor layer 131 that are arranged over the substrate 132. For example, the first and the third semiconductor layers 125, 131 may be of the first conductivity type, e.g. n-type, and the second semiconductor layer 128 may be of the second conductivity type, e.g. p-type. For example, the second semiconductor layer may comprise a first sub-layer 128 and a second sub-layer 129. For example, the second sub-layer 129 and the third semiconductor layer 131 may implement a light absorbing pn-junction.

Further, the first sub-layer 128 may implement the base region 135 of the bipolar transistor. The first semiconductor layer 125 may implement the emitter region 136 of the phototransistor 110. The first semiconductor layer 5 may be electrically connected via a first ohmic contact 124 to an emitter contact 121. The third semiconductor layer 131 may implement a collector 137. The collector region 137 may be electrically connected to a collector contact 130. A reflecting layer stack 127 may e.g. be implemented by semiconductor layers of the first conductivity types, which form a Bragg reflector. For example, the reflecting layer stack 127 may comprise a plurality of doped layers of the same conductivity type as the emitter region 136. The doped layers may have a mutually varying refractive index. For example, this may be accomplished by alternating the doping concentration or a composition ratio of the single layers. Each boundary between adjacent layers causes a partial reflection of an optical wave that travels back to the emitter so that a positive feedback may be suppressed.

The reflecting layer stack 127 may be arranged between the first sublayer 128 of the second semiconductor layer and the first semiconductor layer 125. The low doped semiconductor layer 126 may be arranged between the first semiconductor layer 125 and the reflecting layer stack 127.

The semiconductor layer stack comprising the second semiconductor layer 128, 129, the reflecting layer stack 127, and the first semiconductor layer 125 may be patterned to form a mesa. A passivation layer 123 may be arranged on a side wall of the mesa. An antireflection coating 122 may be arranged over the first ohmic contact layer 124. A further antireflection coating 133 may be arranged on a light receiving side of the substrate 132.

FIG. 2D shows a cross-sectional view of the phototransistor 110 according to further embodiments. Differing from embodiments illustrated in FIG. 2C, the phototransistor 110 further comprises a base contact 134 which is electrically connected to the first sub-layer 128 of the second semiconductor layer. The further components are similar to those explained with reference to FIG. 2C.

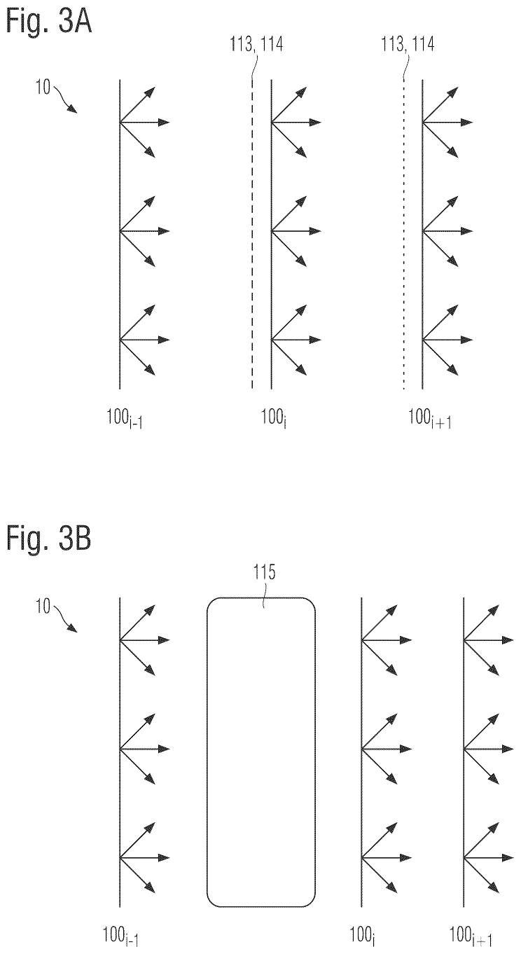

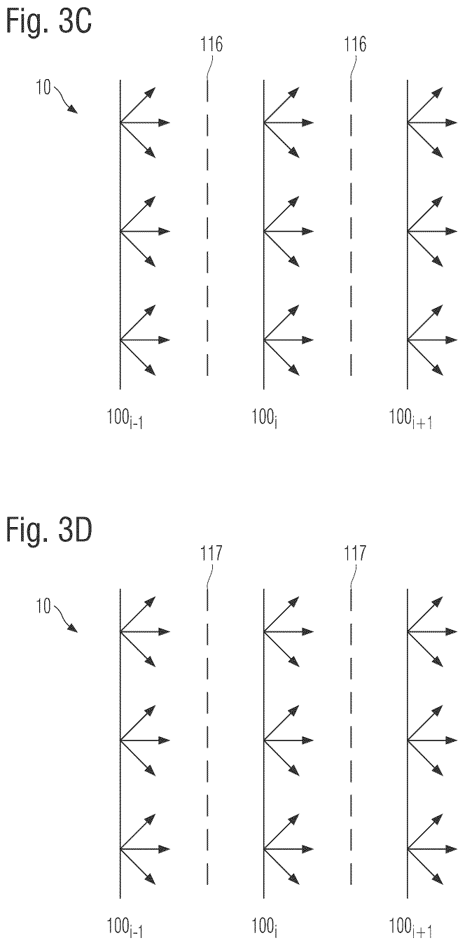

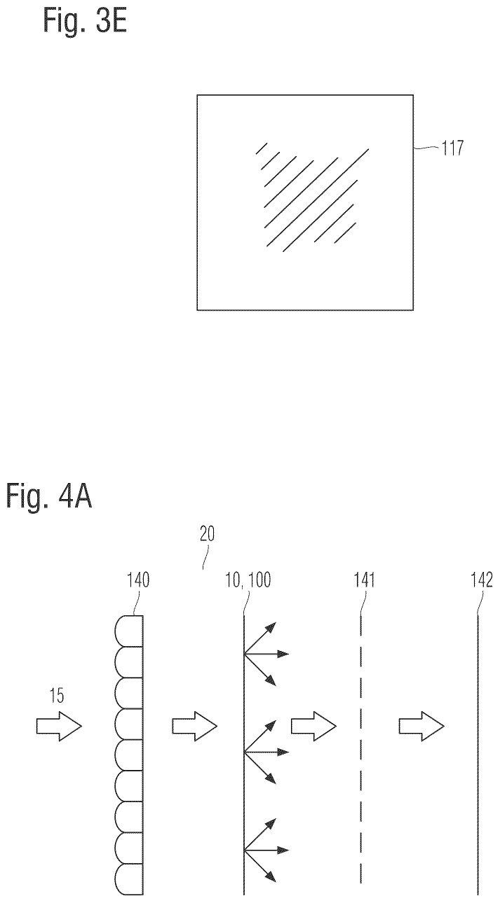

FIG. 3A shows an example of a neural network 10 according to further embodiments. As is shown, passive convolutional layers 113 may be arranged between some or all artificial neural network layers 100. For example, the passive convolutional layer may be implemented by a mask that may e.g. an amplitude or a phase mask. According to further embodiments, the passive convolutional layer 113 may as well be a layer of diffusive material, a polarising layer or diffractive elements. For example, if the passive layer 113 is implemented as a diffuser, the Lambertian property of the artificial neural network layer may be enhanced. In more detail, the light emitted by the phototransistors may be diffused so that the light intensity emitted by each emitter reaches each receiver of the next layer. As a consequence, the density of phototransistors 110 in the next artificial neural network layer 100 may be reduced. The passive convolutional layer may be a lensless layer.

According to further implementations, an active convolutional layer 114 may be arranged between adjacent layers.

The active convolutional layer 114 may be a lensless element. Examples of an active element 114 comprises a liquid crystal display, special light modulators or vanadium oxide transistor matrices.

FIG. 3B shows a further example of a neural network 10. A reservoir 115 may be arranged between adjacent neural network layers 100. The reservoir 115 may be configured to store information and may be part of a recurrent neural network. When the output produced by the reservoir has a higher dimension than the inputs, since e.g. since a single spot creates a speckle, sparsely connected and keeping a consistent relationship between the input and the output, the system can be used as a reservoir neural network. In this case, only few neural network layers 100 on the light output side of the reservoir 115 need to be trained.

For example, the reservoir 114 may comprise an optical material e.g. a disordered medium such as a white paint, a piece of a multimode optical fibre and others.

FIG. 3C shows a further example of a neural network 10 according to embodiments. As is shown, a phase-changing material 116 may be arranged between adjacent neural network layers. For example, the phase-change layer 116 may be changed from an amorphous state to a crystalline state and vice versa by applying optical or electrical pulses. For example, due to the change of the phase, the refractive index of the phase-changing material 116 may be changed. Due to the presence of the phase-changing material 116, synaptic neurons may be implemented. For example, incident light intensity on such materials allows for a stable change of the refractive index. These changes are stored permanently in the crystal state of the phase-change material. For example, the number of levels in refractive index may depend on the optical contrast and the noise. For example, the optical reconfiguration may occur within sub-nanoseconds and by applying an external electrical pulse the state of the phase changing material can be set to the default. Using a phase-changing material 116 between neural network layers makes it possible to store weights in the crystal layer itself. As a result, the need for memory allocation for storing the weight and the hardware and the bus connections may be dispensed with. An example of a suitable phase-changing material 116 comprises GST (Ge₂Sb₂Te₅), ferroelectric crystals and volume holograms.

FIG. 3D shows a further example of a neural network 10 according to embodiments. As is illustrated, an optical grating 117 may be arranged between layers of the artificial neural network. For example, the optical grating 117 may comprise a photorefractive material. The photorefractive material may be used to store weights. For example, the gratings may be written using two interfering optical beams using the photorefractive effect. By way of example, these layers may comprise thin layers of silicon. Accordingly, the weights may be stored in the photorefractive gratings 117. As a result, there is no need to store the weights in an external memory.

FIG. 3E shows an example of an optical grating 117 that may be formed using two interfering optical beams that are irradiated on a photorefractive material.

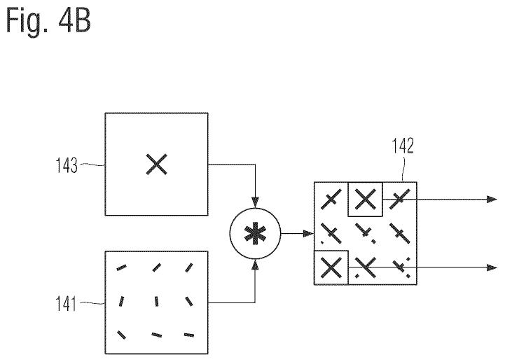

FIG. 4A shows a schematic drawing of an image sensor 20 which may comprise the above-described artificial neural network layer 100 or artificial network 10. The image sensor 20 may comprise a micro lens array 140 that may be arranged in front of an artificial neural network layer 100. A feature mask 141 may be arranged behind the artificial neural network layer 100. Further, an image sensor 142 may be arranged behind the feature mask 141. For example, the micro lens array 140 may be used to focus and efficiently collect the incident light 15. After the light 15 has passed through the lens array 140, it is no longer Lambertian. The neural network layer 100 amplifies the light or implements a certain operation on the incoming light. Due to the presence of a neural network layer 100, incoming light may be converted to a Lambertian light. Further, the incoming light wavelength may be converted and may be adapted to the image sensor detection range. According to further implementations, an artificial neural network 10 comprising several artificial network layers 100 may be arranged before the feature mask 141.

The effect of the feature mask 141 is explained with reference to FIG. 4B. The feature mask 141 may be a passive element, for example, when a fixed task is to be accomplished. Alternatively, the feature mask 141 may be an active element, which may be adapted to a task. Input light passes through the feature mask 141 and performs convolution with a mask pattern. Thereafter, by simply pooling the maximum values on the sensor image, features can be recognized. As a result, the object may be detected. For example, the artificial network layer 110 may correspond to the artificial network layer illustrated in FIG. 1A. In this arrangement the neural network layer 100 can even be used to convert the wavelength of incoming electromagnetic radiation. The neural network layer may further be adapted to the detection range of the image sensor.

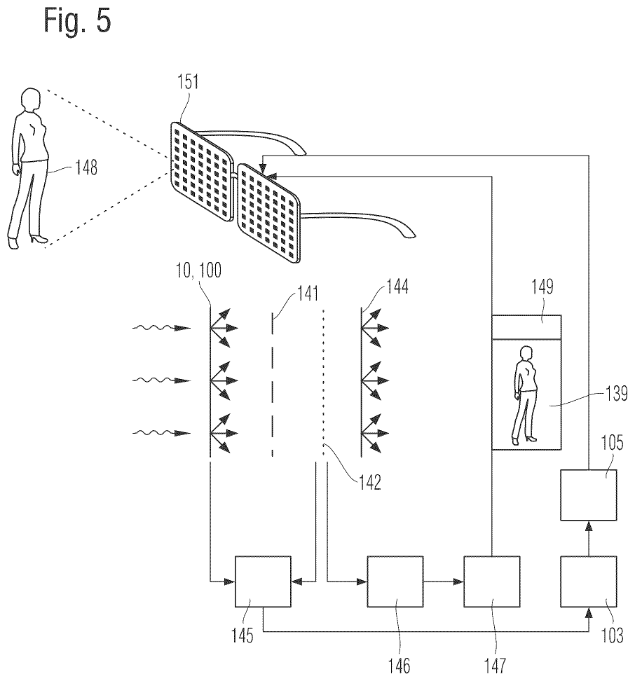

FIG. 5 shows an electronic device, e.g. smart glasses 151 which may comprise the neural network layer 100 or the artificial network 10 which has been explained above. For example, the array of phototransistors 110 may be sparsely organised on a suitable substrate, e.g. glass substrate so as to keep a certain transparency. For example, the transparency may be larger than 60%, e.g. about 70%, when a sensor pitch corresponds to 100 μm.

For example, the neural network may be configured to recognize an object 148. By coupling the neural network 10 or the artificial neural network layer 100 with a display, the result of the operation may be superimposed to the user line of sight. Examples of the display comprise an OLED (“organic light emitting diode”), μLED (“micro light emitting diode”), an LCD (“liquid crystal display”) and others.

For example, the electronic device or the artificial neural network 10 according to all embodiments may further comprise a training processor 145. The training processor 145 may be an external component which is used only to train the artificial neural network 10 depending on a task to be accomplished and the criteria used for the weights' optimization (e.g. gradient descent). During this training, the training processor 145 adapts the weights for the artificial neural network 10. According to further implementations, the training processor 145 may be an internal component and may, for example, be also used for object or pattern recognition.

For example, the weights optimization using the gradient descent or backpropagation algorithm aims to minimize a loss function. The loss function may quantify the divergence of the current output of the artificial network or value from the ideal/expected output or value, via gradient descent. For example, the following steps may be repeated until convergence: (1) forward propagation of information through the artificial neural network; (2) evaluation of the loss function gradients with respect to the network parameters at the output layer; (3) backpropagation of these gradients to all previous layers; (4) parameter updates in the direction that maximally reduces the loss function.

These values are stored in a memory 103 which may e.g. a look-up table comprising voltage values used for the bias circuits which are applied to the phototransistors 110 of the neural network 10.

If an object 148, e.g. a person, is in front of the system, the image is pre-processed by the neural network 10. The result of detection is then passed to a local processor 146 e.g. a CPU, which may finalize the scoring for classification, extract further features, or may only drive the display 144 to show the result. For example, the CPU 146 may drive a display driver 147, which enables that an image 139 and identification information 149 are displayed on the glasses. The electronic device further comprises the memory 103 and a bias circuit 105 for applying biases voltages to the respective phototransistors 110.

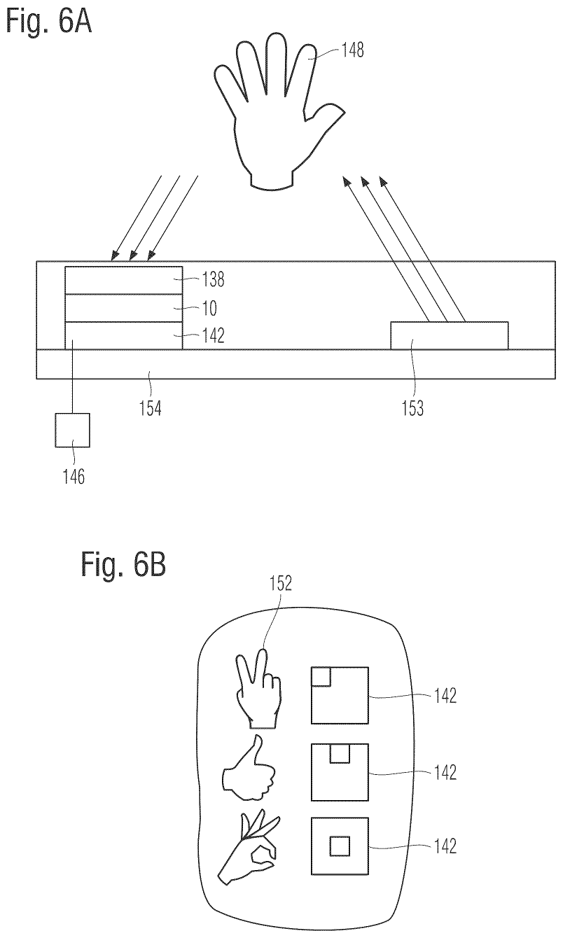

FIG. 6A shows a schematic view of a gesture recognition unit 154 according to embodiments. As is to be clearly understood, the concepts described may be likewise applied to pattern recognition. The gesture recognition unit 154 comprises an emitter or an emitter array 153 for emitting electromagnetic radiation, which may be reflected by an object 148 which has a specific gesture. The reflected electromagnetic radiation is received by an image sensor 142 comprising a neural network 10 and e.g. a micro lens array 140 as has been explained with reference to FIG. 5. By suitably evaluating the image sensed by the image sensor 142, the gesture 152 may be detected, as is also illustrated in FIG. 6B. For example, the neural network layers 110 constituting the neural network 10 may be integrated in a compact package, which is used as the gesture recognition unit 154. The emitter 153 may e.g. comprise an LED, e.g. an infrared LED or a VCSEL (“vertical cavity surface emitting laser”).

The optical element 138 may e.g. to be implemented by a lens for a higher light throughput or by an amplitude or phase mask. The neural network 10 may be pre-trained and properly biased. The image sensor 142 senses the light emitted by the neural network 10. The image sensor 142 may be connected to a CPU 146 or a local microcontroller which may finalize the result. The result may e.g. be displayed or some action may be triggered.

Based on the application and the training, the observed gesture 152 is processed by the neural network 10 in a way, that only a specific area of the image sensor 142 receives a signal having a higher intensity. As a result, the CPU 146 may perform the pre-programmed action.

As has been described above, the artificial neural network layer 100 comprising an array of phototransistors 110 provides an increased flexibility. Therefore, the artificial neural network layer 100 and an artificial neural network 10 comprising a plurality of artificial neural network layers may be applied in a variety of applications.

The effect of such an artificial neural network 10 is that the connections between adjacent layers are linked by photons and the layer adjustments are electrical.

As a result, the flexibility may be increased. Known diffractive neural networks are optimized via traditional algorithm based on digital calculators. This makes the training computationally expensive and the design fixed for a single task. In contrast, the neural network described herein may be trained by using the same hardware, and due to the fact that weights and biases are electronically controlled the system is fully reconfigurable for different tasks. Moreover, training may be faster accomplished. As a further consequence, the signal to noise ratio may be improved.

By having transistors as sensing and emitting elements, the matrices are active, therefore more sensitive to small incoming signals and providing higher outputs. In contrast, known diffractive neural networks are passive, thus require higher input signals and a larger degradation of signals along the layers.

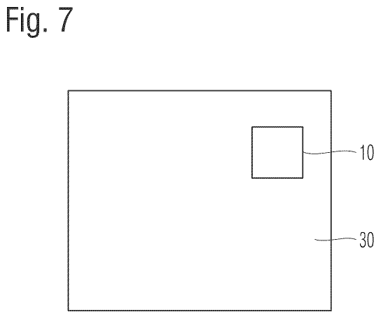

FIG. 7 shows an electronic device 30 according to embodiments. The electronic device comprises the artificial neural network 10 that has been explained above. Examples of the electronic device 30 comprise smart devices such as smartphones, smartglasses, AR-devices (“augmented reality”), VR-devices (“virtual reality”), XR-devices (“mixed reality”), automotive applications, medical devices, surveillance devices, computers, laptops and tablets. As is clearly to be understood, the electronic device 30 may comprise a plurality of artificial neural networks as described hereinabove. For example, the electronic device may comprise a plurality of building blocks, each or some of the building blocks comprising the artificial neural network as described herein. For example, some of the building blocks may comprise different components.

While embodiments of the invention have been described above, it is obvious that further embodiments may be implemented. For example, further embodiments may comprise any subcombination of features recited in the claims or any subcombination of elements described in the examples given above. Accordingly, this spirit and scope of the appended claims should not be limited to the description of the embodiments contained herein.

1.-13. (canceled)

14. An artificial neural network layer comprising:
an array of phototransistors,
wherein each of the phototransistors is configured to absorb electromagnetic radiation via a light-receiving surface of the phototransistor and to emit electromagnetic radiation via a light-emitting surface,
wherein an intensity of the emitted electromagnetic radiation depends on an intensity of the absorbed electromagnetic radiation,
wherein the intensity of the emitted electromagnetic radiation further depends on a voltage applied to at least one terminal of the phototransistor, and
wherein the array of phototransistors is arranged in a plane parallel to the light-receiving surface.

15. The artificial neural network layer according to claim 14,
wherein each of the phototransistors is a bipolar junction transistor comprising:
a collector region adjacent to the light-receiving surface,
an emitter region adjacent to the light-emitting surface, and
a base region between the collector region and the emitter region, and
wherein each phototransistor is biasable so that the collector and base regions of the phototransistor operate as a photodiode and so that the base and emitter regions operate as a light-emitting diode.

16. The artificial neural network layer according to claim 14, further comprising a bias circuit configured to apply a voltage to at least one terminal of each of the phototransistor.

17. The artificial neural network layer according to claim 14, further comprising a bias circuit configured to apply a voltage to at least one terminal of a corresponding one of the phototransistors.

18. The artificial neural network layer according to claim 14, further comprising a memory configured to store voltage values applicable to the at least one terminal.

19. An artificial neural network comprising:
at least two artificial neural network layers, the artificial neural network layers comprising an array of phototransistors,
wherein each of the phototransistors is configured to absorb electromagnetic radiation via a light-receiving surface of the phototransistor and to emit electromagnetic radiation via a light-emitting surface,
wherein an intensity of the emitted electromagnetic radiation depends on an intensity of the absorbed electromagnetic radiation,
wherein the intensity of the emitted electromagnetic radiation further depends on a voltage applied to at least one terminal of the phototransistor, and
wherein the array of phototransistors is arranged in a plane parallel to the light-receiving surface.

20. The artificial neural network according to claim 19, further comprising a training processor configured to train the neural network.

21. The artificial neural network according to claim 19, further comprising a processor configured to perform image recognition.

22. The artificial neural network according to claim 19, further comprising a modulator or a diffuser between two neighboring artificial neural network layers.

23. The artificial neural network according to claim 19, further comprising a mask between two neighboring artificial neural network layers, the mask being selected from an amplitude mask or a phase mask.

24. The artificial neural network according to claim 19, further comprising a reservoir between two neighboring artificial neural network layers.

25. An electronic device comprising:
an artificial neural network layer, the artificial neural network layer comprising an array of phototransistors,
wherein each of the phototransistors is configured to absorb electromagnetic radiation via a light-receiving surface of the phototransistor and to emit electromagnetic radiation via a light-emitting surface,
wherein an intensity of the emitted electromagnetic radiation depend on an intensity of the absorbed electromagnetic radiation,
wherein the intensity of the emitted electromagnetic radiation further depends on a voltage applied to at least one terminal of the phototransistor, and
wherein the array of phototransistors is arranged in a plane parallel to the light-receiving surface.

26. The electronic device according to claim 25, wherein the electronic device is a gesture recognition unit, a pattern recognition unit, an image sensor or a display comprising an image sensor.

27. An electronic device comprising:
an artificial neural network,
wherein the artificial neural network comprises at least two artificial neural network layers,
wherein the artificial neural network layers comprises an array of phototransistors,
wherein each of the phototransistors is configured to absorb electromagnetic radiation via a light-receiving surface of the phototransistor and to emit electromagnetic radiation via a light-emitting surface,
wherein an intensity of the emitted electromagnetic radiation depends on an intensity of the absorbed electromagnetic radiation,
wherein the intensity of the emitted electromagnetic radiation further depends on a voltage applied to at least one terminal of the phototransistor, and
wherein the array of phototransistors is arranged in a plane parallel to the light-receiving surface.

28. The electronic device according to claim 27, wherein the electronic device is a gesture recognition unit, a pattern recognition unit, an image sensor or a display comprising an image sensor.
